(19) United States
(12) Patent Application Publication
(10) Pub. No.: US 2021/0329901 A1
(43) Pub. Date: Oct. 28, 2021

(54) FISHING DEVICE

(71) Applicant: Courtney A. Gust, III, Muskegon, MI (US)

(72) Inventor: Courtney A. Gust, III, Muskegon, MI (US)

(21) Appl. No.: 16/860,364

(22) Filed: Apr. 28, 2020

(51) Int. Cl. A01K 99/00

(52) U.S. Cl. CPC A01K 99/00

(57) ABSTRACT

A fishing device for engagement with a fishing line includes a motor, a power source, a housing, and an actuator assembly. The power source provides power to the motor. The housing defines an interior cavity. The housing prevents water from interacting with the motor and the power source. The actuator assembly is driven by the motor. The actuator assembly is configured to provide movement to the fishing line.

### FIELD OF THE INVENTION

The present invention generally relates to fishing devices. More specifically, the present invention relates to various fishing devices that provide supplemental action to a corresponding fishing line and lure.

### BACKGROUND OF THE INVENTION

Fisherman, or anglers, often utilize bait when seeking to catch fish. The bait is often either live bait or artificial bait. However, many bait options that are available to anglers require active maneuvering on the part of the angler to impart action to the bait. These maneuvering actions are imparted to the bait through the manual motions and activities of the angler.

### SUMMARY OF THE INVENTION

According to one aspect of the present invention, a fishing device for engagement with a fishing line includes a motor, a power source, a housing, and an actuator assembly. The power source provides power to the motor. The housing defines an interior cavity. The housing prevents water from interacting with at least a portion of the motor and the power source. The actuator assembly is driven by the motor. The actuator assembly is configured to provide movement to the fishing line.

According to another aspect of the present invention, a fishing device for engagement with a fishing line includes a motor, a power source, a housing, and an actuator assembly. The power source provides power to the motor. The housing defines an interior cavity. The housing prevents water from interacting with at least a portion of the motor and the power source. The actuator assembly is driven by the motor. The actuator assembly is configured to provide movement to the fishing line. A fishing device for engagement with a fishing line and an actuator assembly includes a driveshaft, a pinion gear, and a rack. The driveshaft has a first end and a second end. The first end engages with the motor. The pinion gear is coupled to the second end of the driveshaft. The rack has a first portion and a second portion. The rack engages with the pinion gear. The rack is operable between a retracted position and an extended position.

According to another aspect of the present invention, a fishing device for engagement with a fishing line includes a motor, a power source, a housing, and an actuator assembly. The power source provides power to the motor. The housing defines an interior cavity. The housing prevents water from interacting with at least a portion of the motor and the power source. The actuator assembly is driven by the motor. The actuator assembly is configured to provide movement to the fishing line. A fishing device for engagement with a fishing line and an actuator assembly includes a driveshaft and a cam. The driveshaft has a first end and a second end. The first end engages with the motor. The cam is coupled to the second end of the driveshaft.

According to another aspect of the present invention, a fishing device for engagement with a fishing line includes a motor, a power source, a housing, and an actuator assembly. The power source provides power to the motor. The housing defines an interior cavity. The housing prevents water from interacting with at least a portion of the motor and the power source. The actuator assembly is driven by the motor. The actuator assembly is configured to provide movement to the fishing line. The fishing device for engagement with a fishing line and an actuator assembly includes a driveshaft and a lever arm. The driveshaft has a first end and a second end. The first end engages with the motor. The lever arm has a first lever end and a second lever end. The first lever end of the lever arm is coupled to the second end of the driveshaft.

According to another aspect of the present invention, a fishing device for engagement with a fishing line includes a motor, a power source, a housing, and an actuator assembly. The power source provides power to the motor. The housing defines an interior cavity. The housing prevents water from interacting with at least a portion of the motor and the power source. The actuator assembly is driven by the motor. The actuator assembly is configured to provide movement to the fishing line. The fishing device for engagement with a fishing line and an actuator assembly includes a driveshaft, a belt gear, a transmission shaft, a transmission gear, and a belt. The driveshaft has a first end and a second end. The first end engages with the motor. The belt gear couples to the second end of the driveshaft. The transmission shaft has a first shaft end and a second shaft end. The first shaft end engages with the housing. The transmission gear defines the transmission shaft and is positioned between the first shaft end and the second shaft end of the transmission shaft. The belt extends between the belt gear of the driveshaft and the transmission gear of the transmission shaft.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side view of a fishing device deployed from a watercraft below a surface of water, according to one example;

FIG. 2 is a side view of the fishing device deployed from the watercraft below the surface of the water, according to another example;

FIG. 3 is a side view of the fishing device, illustrating an actuator assembly in a rack and pinion arrangement, shown with a cover plate removed, according to one example;

FIG. 4 is a side cross-sectional view of the fishing device, illustrating the actuator assembly in a rack and pinion arrangement, according to another example;

FIG. 5 is a side cross-sectional view of the fishing device, illustrating the actuator assembly in a rack and pinion arrangement, according to one example;

FIG. 6 is a side view of the fishing device, illustrating the actuator assembly in a linkage arm arrangement, according to one example;

FIG. 7 is a cross-sectional view of the fishing device of FIG. 6, taken along line VII-VII, and illustrating the linkage arm arrangement, according to one example;

FIG. 8 is a side cross-sectional view of the fishing device, illustrating the actuator assembly in a linkage arm arrangement, according to another example;

FIG. 9 is a side cross-sectional view of the fishing device, illustrating the actuator assembly in a lever arm arrangement, according to one example;

FIG. 10 is a schematic side perspective view of the fishing device, illustrating the actuator assembly in a lever arm arrangement, according to another example;

FIG. 11 is a schematic side view of the fishing device, illustrating the actuator assembly in a lever arm arrangement positioned on a fishing rod, according to one example;

FIG. 12A is a schematic side perspective view of the fishing device, illustrating a cam and a spring-engaged rod of the actuator assembly with the spring-engaged rod in a first position, according to one example;

FIG. 12B is a schematic side perspective view of the fishing device of FIG. 12A, illustrating the cam and the spring-engaged rod of the actuator assembly with the spring-engaged rod in a second position, according to one example;

FIG. 13 is a schematic side view of the fishing device, illustrating the actuator assembly having the spring-engaged rod and the cam, according to one example;

FIG. 14 is a schematic side view of the fishing device, illustrating the cam and the spring-engaged rod of the actuator assembly, according to another example;

FIG. 15 is a schematic side perspective view of the fishing device, illustrating the actuator assembly with a vibratory motor, according to one example;

FIG. 16 is a schematic side view of the fishing device, illustrating the actuator assembly in a belt-driven arrangement, according to one example;

FIG. 17 is a schematic side view of the fishing device, illustrating the actuator assembly in a belt-driven arrangement, according to another example;

FIG. 18 is a side perspective view of a transmission shaft of the actuator assembly of FIG. 17, as utilized in the belt-driven arrangement, according to one example; and

FIG. 19 is a schematic cross sectional view of a fishing device incorporating an aspect of the cam and a spring-engaged rod, according to one example.

### DETAILED DESCRIPTION OF THE PREFERRED EMBODIMENTS

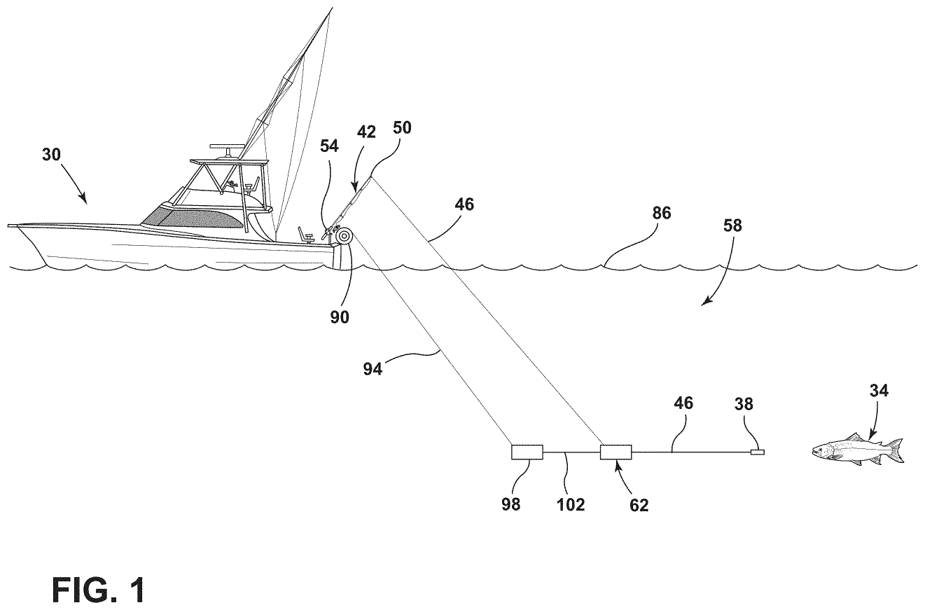

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

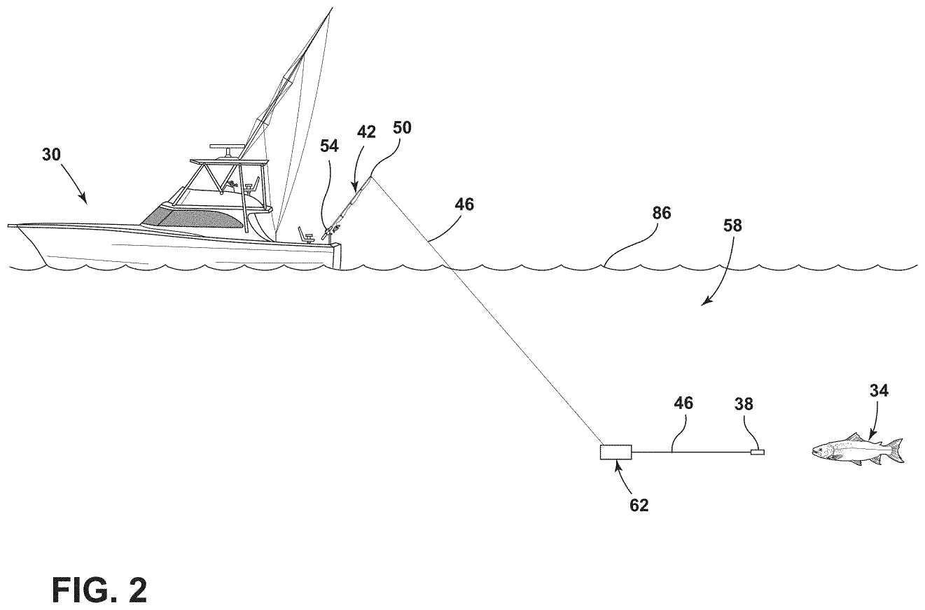

Referring to FIGS. 1 and 2, reference numeral 30 generally indicates a watercraft. The watercraft 30 may be utilized for fishing, or angling, for fish 34. In general, fisherman, or anglers, utilize a lure 38 (e.g., live bait or artificial bait) that is coupled to a fishing pole 42 by way of a fishing line 46 to entice the fish 34 to strike the lure 38 in an effort to secure the fish 34 upon a hook that is coupled to the lure 38. The fishing pole 42 includes a fishing rod 50 and a reel 54 that is coupled to the fishing rod 50. The lure 38 may be provided with a scent and/or a degree of movement.

Using conventional fishing equipment, the degree of movement can be based upon either movement from live bait or designed movement of artificial bait. However, the designed movement of conventional artificial bait is often dependent upon the angler providing action to the fishing pole 42, which is transmitted along the fishing line 46 to the conventional lure, or through the motion of water passing around the conventional lure. The action provided by the angler to the fishing pole 42 may be accomplished by the angler reeling in the fishing line, adjusting a vertical position of a distal end of the fishing pole, or otherwise causing the conventional lure to move through water 58 upon which the watercraft 30 is floating.

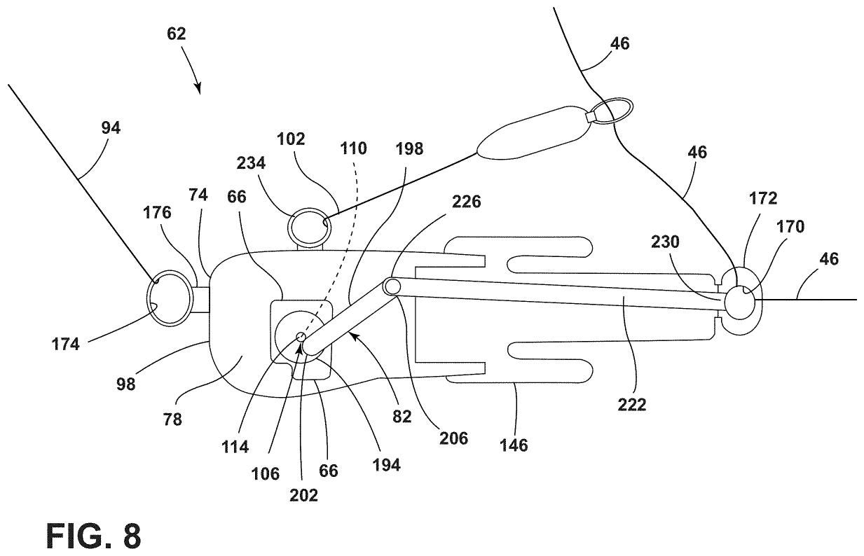

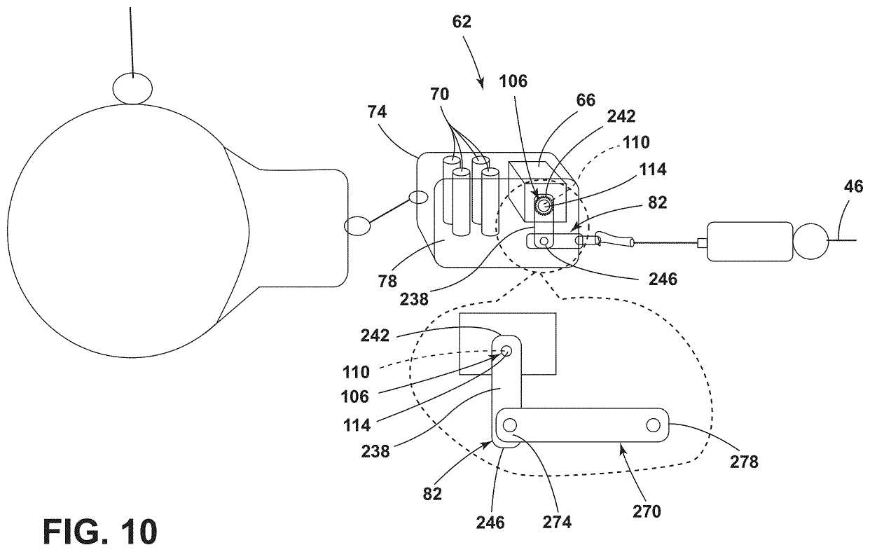

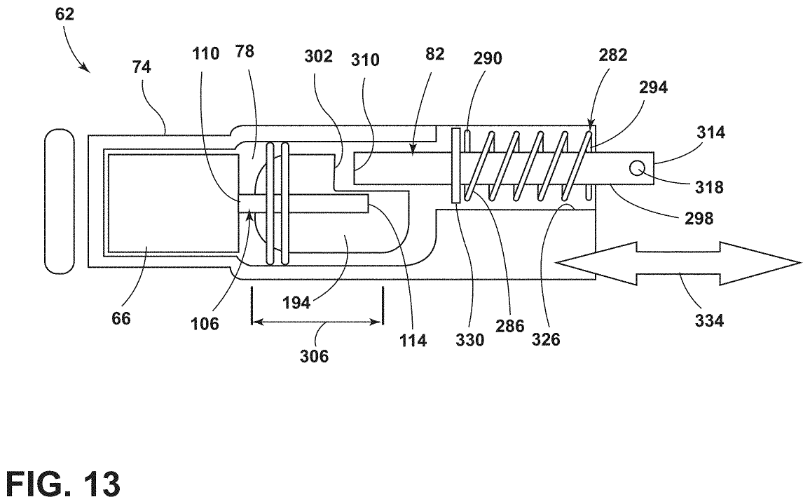

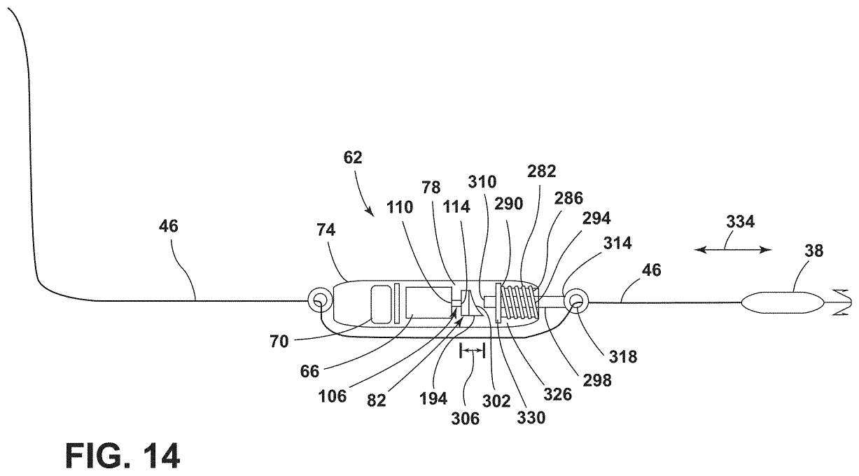

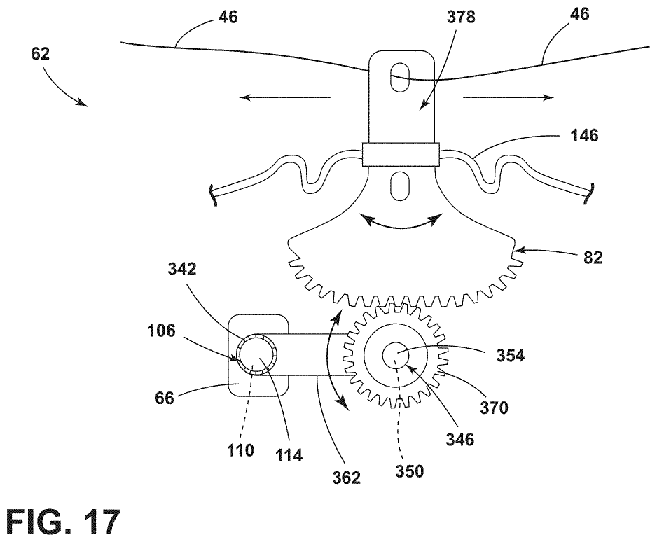

As exemplified in FIGS. 1-18, the present disclosure provides a fishing device 62 for engagement with the fishing line 46. The fishing device 62 includes a motor 66, a power source 70 that provides power to the motor 66, a housing 74 that defines an interior cavity 78, and an actuator assembly 82 that is driven by the motor 66. The housing 74 prevents water 58 from interacting with the power source 70 and at least a portion of the motor 66. The actuator assembly 82 is configured to provide movement to the fishing line 46, where the fishing line 46 can include the lure 38 and various fishing-line related equipment, as will be described more fully herein.

Referring again to FIGS. 1 and 2, anglers utilize a variety of tackle, such as the lure 38, as well as various techniques intended to cause the fish 34 to take the lure 38, thereby allowing the angler an opportunity to land the fish 34 (i.e., remove the fish 34 from the water 58) for catch-and-release or consumption. Many individuals in the general population are familiar with fishing from a dock, beach, or riverside while utilizing a bobber that floats at a surface 86 of the water 58. Another form of fishing or angling is trolling. Trolling is a method of fishing where one or more of the fishing lines 46, baited with lures 38 or bait fish, are drawn through the water 58. Trolling may be performed behind a moving boat (e.g., the watercraft 30), by slowly winding or spooling the fishing line 46 around the reel 54 when fishing from a static position relative to the watercraft 30, or by sweeping the fishing line 46 from side-to-side. In general, the trolling method of fishing or angling imparts some movement to the lure 38 when a user acts upon the fishing pole 42, which in turn acts upon the fishing line 46. In some instances, the angler may desire to utilize a downrigger setup. A downrigger setup typically includes a boom, a spool 90, a cable 94, and a weight 98. The cable 94 extends between the spool 90 and the weight 98. The boom, the spool 90, and the cable 94 interact in a manner similar to the reel 54, the fishing rod 50, and the lure 38, respectively. That is, the boom extends outwardly from the watercraft 30, the cable 94 is wound around the spool 90, and the weight 98 is coupled to the cable 94. The weight 98 can be coupled to the fishing line 46 and/or the fishing device 62 by a release line 102, with the release line 102 being configured to decouple from the fishing line 46 upon exposure to a predetermined force (e.g., the fish 34 striking or taking the lure 38).

Referring again to FIGS. 1-18, the fishing device 62 of the present disclosure may be utilized with any one or more of the fishing configurations and techniques described herein. The fishing device 62 of the present disclosure acts upon the fishing line 46 to periodically (e.g., in a regular or irregular manner with respect to time) adjust a spatial relationship between the lure 38 and the fishing device 62. Typically, the adjustment of the spatial relationship between the lure 38 and the fishing device 62 is accomplished without spooling or winding the line around a drum (e.g., the reel 54). The term “spooling” or “winding,” as used herein, is intended to refer to a wrapping of the fishing line 46 around a circumference of a support structure (e.g., a drum-like structure) of at least one-hundred-eighty degrees (180°), at least two-hundred-seventy degrees (270°), and/or at least three-hundred-sixty degrees (360°). Accordingly, the terms “spooling” or “winding” are intended to refer to traversals of the fishing line 46 about a circumference of a support structure.

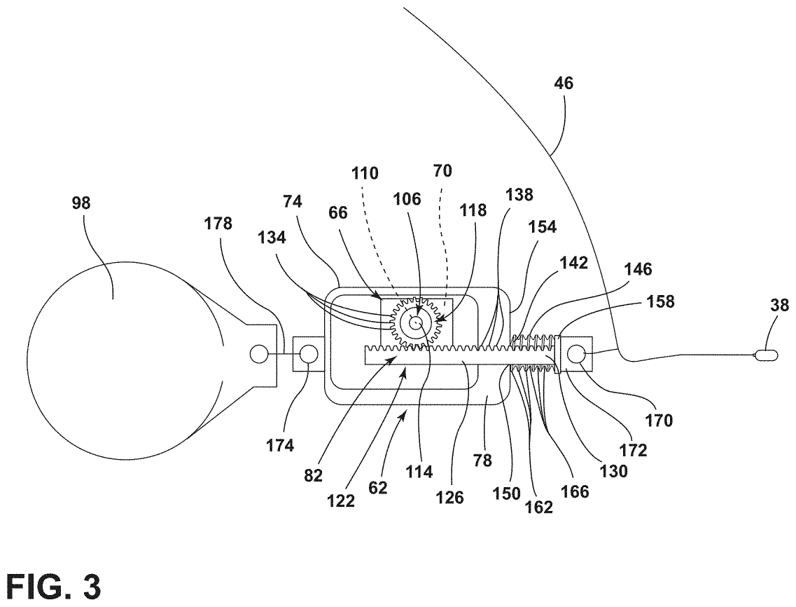

Referring now to FIGS. 3-5, as stated above, the adjustment of the spatial relationship between the lure 38 and the fishing device 62 is accomplished without spooling the fishing line 46 (e.g., around the reel 54 or a drum-like structure). More specifically, movement is provided to the fishing line 46 by the actuator assembly 82 of the fishing device 62, with the movement imparted by the actuator assembly 82. The movement that is imparted to the fishing line 46 by the actuator assembly 82 may be accomplished in a variety of ways, some of which will be discussed in an exemplary fashion herein. The examples of how the actuator assembly 82 effects movement of the fishing line 46 and the associate lure 38 discussed herein are not intended to be an exhaustive or limiting list. Rather, one of skill in the art will recognize that alternative approaches may be employed to utilize various aspects of the actuator assembly 82 without departing from the concepts disclosed herein.

Referring again to FIGS. 3-5, the actuator assembly 82 can include a driveshaft 106 having a first end 110 and a second end 114, with the first end 110 engaging with the motor 66. A pinion gear 118 can be coupled to the second end 114 of the driveshaft 106 of the actuator assembly 82. The actuator assembly 82 can further include a rack 122 that has a first portion 126 and a second portion 130. The first portion 126 of the rack 122 is positioned within the interior cavity 78 that is defined by the housing 74. The second portion 130 of the rack 122 extends to a region that is exterior to the housing 74. As the rack 122 reciprocates relative to the housing 74, the amount of the rack 122 that defines the first and second portions 126, 130 also varies depending on whether the rack 122 is extended or retracted from the housing 74 or in an intermediary position. The rack 122 engages with the pinion gear 118. More specifically, cogs 134 on the pinion gear 118 mesh or otherwise engage with teeth 138 on the rack 122. This meshing engagement of the cogs 134 and the teeth 138 translates the rotational motion of the drive shaft 106 into a linear reciprocation of the rack 122.

The motor 66 is able to drive the driveshaft 106 of the actuator assembly 82 to rotate in at least one of a clockwise and a counter-clockwise direction, or both. The rotation imparted to the driveshaft 106 by the motor 66 can actuate the rack 122 between the first portion 126 and the second portion 130. For example, the rack 122 may be operable between a retracted position and an extended position. In certain aspects of the device, the motor 66 is a bi-directional motor 66 that is able to selectively drive the driveshaft 106 in each of a clockwise and a counter-clockwise direction. This bi-directional motion actuates the rack 122 between the retracted first portion 126 and the extended second portion 130 and may be actively controlled by the motor 66. Accordingly, the cogs 134 and the teeth 138 are continuously engaged with one another to account for the motorized motion of the rack 122.

In certain aspects of the device, the motor 66 is able to drive the driveshaft 106 in one of a clockwise and a counter-clockwise direction. In such a condition, driving the driveshaft 106 in one of the clockwise direction and the counter-clockwise direction may actuate the rack 122, for example, from the extended position to the retracted position. Where a single-directional motor is utilized, reciprocation of the rack can be accomplished through a biasing mechanism that opposes the motion produced by the motor 66. Returning the rack 122 to the extended position (or retracted position depending on the design of the actuator assembly 82) may be accomplished by a biasing force provided by the biasing member 142 to the rack 122 to the extended position. The biasing force may act against the motor 66 such that, upon reaching the retracted position, the motor 66 releases or otherwise allows the rack 122 to rapidly return to the extended position as a result of the biasing force. Such a unidirectional active rotation of the driveshaft 106 by the motor 66 may be accomplished by various interactions between the rack 122 and the driveshaft 106.

By way of example and not limitation, a clutch arrangement or temporary disengagement of the first end 110 of the drive shaft 106 from the motor 66 allows the driveshaft 106 to rotate freely in response to the biasing force acting upon the rack 122. The biasing force may be provided by a biasing member 142 and/or a resilient member 146. In some examples, the biasing member 142 may be a spring, such as a coil spring, that encircles a section of the rack 122 (typically the second portion 130). Alternatively, the biasing member 142 may be a spring, such as a clock spring, that encircles a section of the driveshaft 106. The resilient member 146 is operable between a rest position and a biasing position. The biasing position can be in the form of an extension or a contraction away from the rest position. Because the biasing member 142 is biased toward the rest position, the biasing member 142 can be used to return the rack 122 in a direction opposite to that generated by the motor. In certain aspects of the device, the compressed position of the biasing member 142 can correspond to the retracted first portion 126 of the rack 122. The extended position of the biasing member 142 can correspond to the extended second portion 130 of the rack 122. In either instance, the biasing member 142 exerts the biasing force in the direction of the rest position of the biasing member 142. The reciprocating motion generated by the one way motor can also be generated by an irregular pattern of cogs 134 and teeth 138. As the pinion gear 118 rotates, the cogs 134 may occupy only a portion of the outer circumference of the pinion gear 118. Also or alternatively, the rack 122 may have a gap in the pattern of teeth 138 that are defined therein. These gaps in the cogs 134 and/or teeth 138 allow for a slippage of the rack 122 that is powered by the biasing member 142 and in opposition to the rotational motion of the motor 66 and the pinion gear 118.

In certain aspects of the device, the biasing member 142 can be in the form of a resilient member 146. The resilient member 146 can be a portion of the actuator assembly 82 that also acts as a sealing member that prevents the water 58 from entering the housing 74. The resilient member 146 can be positioned within an aperture 150 defined by the housing 74. The rack 122 extends through the aperture and the resilient member 146 selectively applies the biasing force and also provides a seal through which the rack 122 extends. Said another way, the rack 122 is movable relative to the housing 74, with a section of the rack 122 extending exterior to the interior cavity 78 defined by the housing 74. The aperture 150 is defined by the housing 74 to permit such a reciprocating arrangement of the rack 122 relative to the housing 74. The aperture 150 can also provide an opportunity for the water 58 to enter into the interior cavity 78. Therefore, the resilient member 146 can be provided as a seal to mitigate or eliminate the entry of the water 58 entering into at least a portion of the interior cavity 78 and potentially causing damage to internal components of the actuator assembly 82 (e.g., the motor 66, the driveshaft 106, the pinion gear 118, and/or the rack 122).

In certain aspects of the device, the housing 74 can be designed to allow for an at least partial infiltration of water 58 into the interior cavity 78. In such an aspect of the device, certain interior components of the actuator assembly 82 can be separately sealed or may be designed to be operable when submerged in water 58.

The resilient member 146 may be coupled to the housing 74 at a first end, while a second end of the resilient member 146 may be coupled to the second portion 130 of the rack 122. The resilient member 146 can be made from a pliable material (e.g., a polymer) that can undergo numerous compression-expansion cycles while limiting wear and tear to the resilient member 146 that could result in perforations developing in the resilient member 146. The material from which the resilient member 146 may provide a degree of elasticity, or a biasing force, may urge the resilient member 146 to oppose a force provided by the movement of the rack 122 from the extended position to the retracted position. Accordingly, the resilient member 146 may also serve as the biasing member 142, in some examples. The resilient member 146 may be referred to as a “boot” that encircles a section of the rack 122 and/or the biasing member 142, with the resilient member 146 being positioned between an exterior surface 154 of the housing 74 and a collar 158 provided at a terminal end of the rack 122.

In various examples, the biasing member 142 may be coupled within the resilient member 146. In such a configuration, the biasing member can be covered or coated by at least a portion of the resilient member 146. It is also contemplated that the biasing member 142 extends into, or forms, ridges 162 within the resilient member 146. The ridges 162 may define valleys 166 therebetween. For example, coils of a coil spring may engage with an interior surface of the resilient member 146 such that the ridges 162 are defined as regions where the coils are in direct physical contact with the resilient member 146, while the valleys 166 represent regions corresponding to the spaces between the coils where there may not be direct physical contact between the resilient member 146 and the coils.

It is also contemplated that the biasing member 142 may be utilized while the resilient member 146 is omitted. Similarly, the resilient member 146 may be utilized while the biasing member 142 is omitted, or the biasing member 142 and the resilient member 146 may be used in conjunction with one another without departing from the concepts disclosed herein.

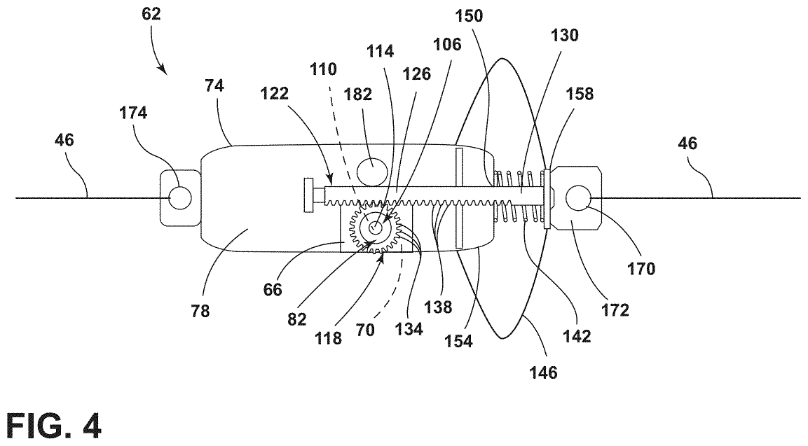

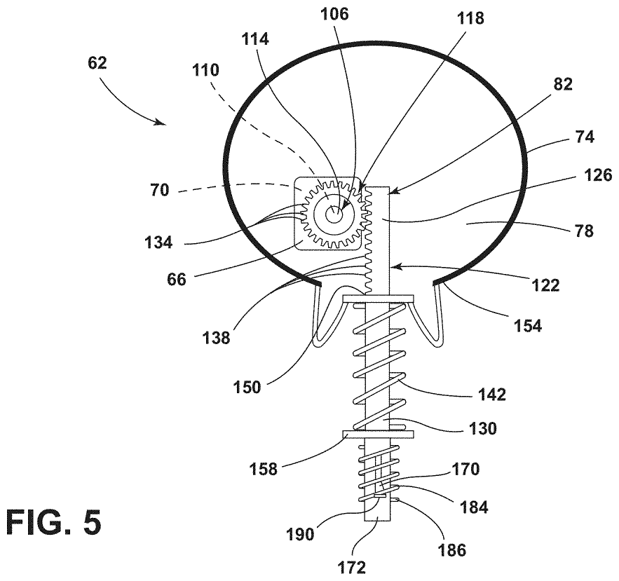

Referring again to FIGS. 3-5, a first eyelet 170 may be defined in a structure 172 that is provided on an end of the collar 158. The structure 172 provided on the end of the collar 158 is opposite an end of the collar 158 that engages with the terminal end of the rack 122. Accordingly, the collar 158 may be positioned between the terminal end of the rack 122 and the structure 172 that defines the first eyelet 170. The release line 102 (shown in FIG. 2) may extend from the first eyelet 170 to the fishing line 46 (e.g., in trolling arrangements). Alternatively, the fishing line 46 may engage with the first eyelet 170 directly, such as with the fishing device 62 depicted in FIGS. 4 and 5.

In various examples, a second eyelet 174 may be defined by a structure 176 that is coupled to the housing 74 and extends from an end of the housing 74 that is opposite to an end of the housing 74 that is provided with the aperture 150 for the rack 122. The second eyelet 174 can be coupled to the weight 98 of a downrigger setup by way of a fixed line 178 (i.e., does not release upon the fish 34 striking the lure 38). Alternatively, the second eyelet 174 can be coupled to the fishing line 46 such that the fishing device 62 is in line with the fishing line 46. Said another way, the fishing device 62 may bisect the fishing line 46, with the fishing line 46 being coupled to the first eyelet 170 and the second eyelet 174. In such an example, the fishing line 46 that extends away from the first eyelet 170 may extend to the lure 38. The fishing line 46 that extends away from the second eyelet 174 may extend to the reel 54 on the fishing pole 42.

In some examples, as exemplified in FIG. 4, the fishing device 62 may be provided with a guide member 182 that aids in guiding the rack 122 through actuation between the extended position and the retracted position. The guide member 182 may be a static structure within the interior cavity 78 of the housing 74. Alternatively, the guide member 182 may be a dynamic, or moving, structure within the interior cavity 78 of the housing 74 (e.g., the guide member 182 may rotate about a fixed rotational axis).

Referring further to FIGS. 3-5, the interior cavity 78 defined by the housing 74 may provide a degree of buoyancy to the fishing device 62. Accordingly, the fishing device 62, in some examples, may be utilized as a bobber and may be configured to resemble a bobber (see FIG. 5). In examples where the fishing device 62 is utilized for the additional functionality of a bobber, the fishing device 62 may be provided with an additional biasing member. In such an example, the biasing member 142 may be referred to as a first biasing member 142 and the additional biasing member may be referred to as a second biasing member 184. The second biasing member 184 may encircle the structure 172 that defines the first eyelet 170. The second biasing member 184 may bear against the collar 158 and a retaining feature 186. The first eyelet 170 can be positioned between the collar 158 and the retaining feature 186.

In use, the second biasing member 184 may be depressed by a user by applying a force away from the retaining feature 186 and toward the collar 158. Applying such a force can reveal an access aperture 190 to the first eyelet 170, with the access aperture 190 being defined by the structure 172. The access aperture 190 can be utilized by a user to place the fishing line 46 within the first eyelet 170. Once the fishing line 46 has been inserted through the access aperture 190 and into the first eyelet 170, the force applied to the second biasing member 184 can be released such that the second biasing member 184 retains the fishing line 46 within the first eyelet 170 and prevents the fishing line 46 from becoming unintentionally decoupled from the structure 172 by way of the access aperture 190.

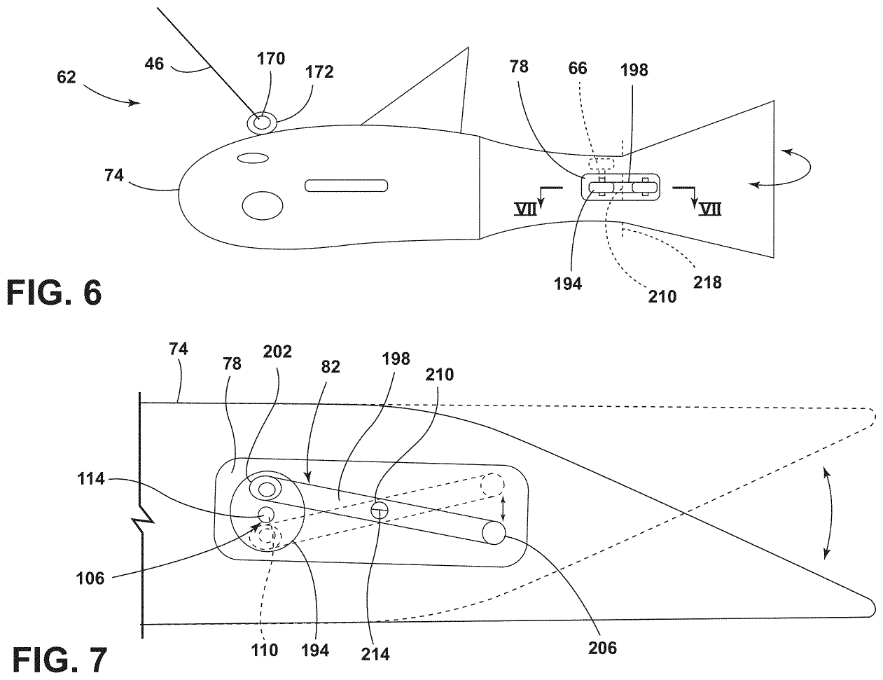

Referring to FIGS. 6-8, the driveshaft 106 of the actuator assembly 82 includes the first end 110 and the second end 114. The first end 110 of the driveshaft 106 engages with the motor 66. A cam 194 is coupled to the second end 114 of the driveshaft 106. In various examples, the cam 194 may have a circular cross-section. It should be understood that other shapes are contemplated for the cam 194. The actuator assembly 82 can include a linkage arm 198 that has a first linkage end 202 and a second linkage end 206. The first linkage end 202 of the linkage arm 198 engages with the cam 194 at an eccentric portion of the cam 194. A fulcrum 210 is positioned between the first linkage end 202 and the second linkage end 206 of the linkage arm 198. In various examples, a pivot pin 214 can be used to provide the fulcrum 210 of the linkage arm 198. The driveshaft 106 typically engages with the cam 194 at or near a center point of the cam 194, while the first linkage end 202 of the linkage arm 198 may engage with the cam 194 at an eccentric point that is radially outward from a center point of the cam 194. Accordingly, as the driveshaft 106 is driven by the motor 66 to rotate the cam 194, the rotation of the cam 194 can result in an oscillation, or see-sawing, of the linkage arm 198 in a repeated motion. Therefore, the movement imparted by the actuator assembly 82 may provide action to the fishing device 62. In some examples, such as that depicted in FIGS. 6 and 7, the fishing device 62 may be configured as bait, such as the lure 38. In such examples, the fulcrum 210 of the linkage arm 198 may be aligned with a living hinge 218 such that movement provided by the actuator assembly 82 provides action to the lure 38 (e.g., a wagging of a tail of a bait fish).

Referring again to FIGS. 6-8, in some examples, the actuator assembly 82 may further include a linkage extension 222. The linkage extension 222 has a first extension end 226 and a second extension end 230. The first extension end 226 of the linkage extension 222 can be coupled to the second linkage end 206 of the linkage arm 198. The second extension end 230 of the linkage extension 222 may engage with the structure 172 that defines the first eyelet 170. As the driveshaft 106 is driven by the motor 66, the cam 194 is rotated. As the cam 194 is rotated, the linkage arm 198 traverses or describes a generally circular path of travel about a center point of the cam 194. The engagement of the linkage arm 198 and the linkage extension 222 translates the rotational motion of the cam 194 into linear, or substantially linear, motion of the structure 172 that defines the first eyelet 170. The structure 172 that defines the first eyelet 170 engages with the fishing line 46. Accordingly, the arrangement of the cam 194, the linkage arm 198, and the linkage extension 222 enables the actuator assembly 82 to impart action or movement to the fishing line 46, which translates into action or movement of the lure 38 associated with the fishing line 46.

Referring again to FIGS. 6-8, the resilient member 146 may be coupled to the housing 74 and the structure 172 that defines the first eyelet 170. Accordingly, as the structure 172 transcribes a linear or substantially linear path of travel, the resilient member 146 may prevent water 58 from interacting with internal components of the fishing device 62 that may not be resistant to water 58. The movement or action imparted to the structure 172 and the engagement of the resilient member 146 may cause the movement or action provided by the actuator assembly 82 to resemble a plunging motion.

In some examples, the fishing device 62 may serve as the weight 98 in a downrigger setup. Therefore, the structure 176 that defines the second eyelet 174 may be coupled to the cable 94. The release line 102 may also couple with the second eyelet 174. Alternatively, a third eyelet 234 may be provided that couples with the release line 102. In either instance, the release line 102 is fixed at one end (e.g., the end coupled to the second or third eyelet 174, 234) and releasably engaged with the fishing line 46 at another end.

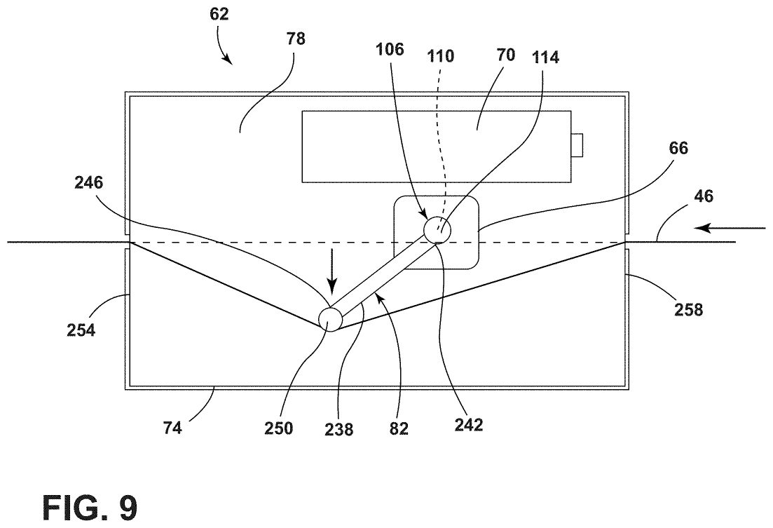

Referring now to FIGS. 9-11, the driveshaft 106 includes the first end 110 and the second end 114. The first end 110 engages with the motor 66. A lever arm 238 having a first lever end 242 and a second lever end 246 may be provided. The first lever end 242 of the lever arm 238 is coupled to the second lever end 114 of the driveshaft 106. The second lever end 246 of the lever arm 238 may be provided with a line-engagement portion 250. The line-engagement portion 250 acts upon the fishing line 46. The lever arm 238 may be rotated or pivoted through a path of travel that is less than about one-hundred-eighty degrees (180°), less than about ninety degrees (90°), or less than about forty-five degrees (45°). Rotation of the driveshaft 106 by the motor 66 can actuate the lever arm 238 and/or the line-engagement portion 250 between engaged and disengaged positions relative to the fishing line 46.

By way of example and not limitation, in the disengaged position, the fishing line 46 may pass through the fishing device 62 (i.e., in a first wall 254 of the housing 74, through the interior cavity 78, and out of a second wall 258 of the housing 74) in a straight line, a substantially straight line, or at least without interacting directly with the lever arm 238 or the line-engagement portion 250. By contrast, in the engaged position, the fishing line 46 may be biased, deflected or otherwise manipulated away from the travel path the fishing line 46 typically assumes when the lever arm 238 and line-engagement portion 250 are in the disengaged position. Accordingly, an effective length of the fishing line 46 downstream of the fishing device 46 is decreased when the lever arm 238 and the line-engagement portion 250 are in the engaged position. That is, more of the fishing line 46 is disposed within the housing 74 such that an effective length of the fishing line 46 between the housing 74 and the lure 38 is decreased. Again, this decrease in the effective length is present as the lever arm 238 and the line engagement portion 250 are in the engaged position. Subsequently, when the lever arm 238 and the line-engagement portion 250 rotate to the disengaged position, the extra portion of the fishing line 46 within the housing is taken out and the effective length of the fishing line 46 downstream of the housing 74 is increased relative to the engaged position. Accordingly, the movement provided by the actuator assembly 82 that adjusts the effective length of the fishing line 46 downstream of the housing 74 provides movement or action to the lure 38 that is associated with the fishing line 46. The repeated rotation of the lever arm 238 and the line-engagement portion 250 between the engaged and disengaged positions can generate a reciprocating motion within the fishing line 46 as well as the lure 38.

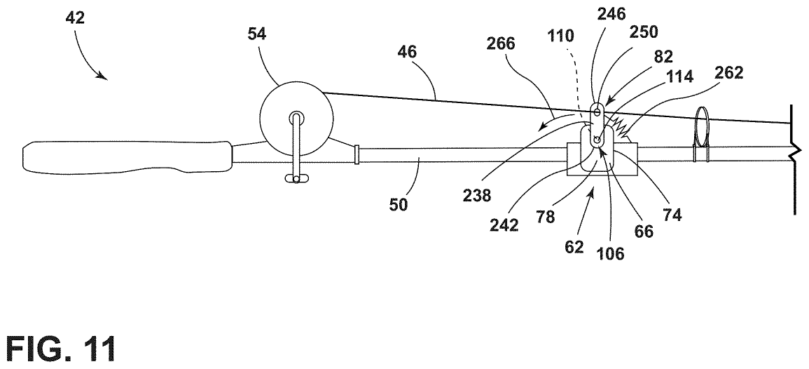

Referring again to FIGS. 9-11, in various examples, the housing 74 or portions of the housing 74 may be omitted when the fishing device 62 is designed to be directly coupled to the fishing rod 50 rather than submerged in the water 58. In one such example, the line-engagement portion 250 may be an aperture defined by the lever arm 238 and positioned at the second end 246 of the lever arm 238. The fishing line 46 passes through the line-engagement portion 250 and the lever arm 238 is biased to a neutral-engagement position, as depicted in FIG. 11. The neutral-engagement position is intended to refer to a state or position in which the fishing line 46 is not impeded by the lever arm 238 or the line-engagement portion 250. A biasing force may be provided by a biasing member 262 that is coupled to the lever arm 238. The motor 66 actuates the lever arm 238 in a direction that opposes the biasing force provided by the biasing member 262, as indicated by arrow 266 in FIG. 11. The biasing force may act against the motor 66 such that, upon reaching a fully-engaged position relative to the fishing line 46 (e.g., ninety degrees (90°) displaced from the neutral-engagement position), the motor 66 releases or otherwise allows the lever arm 238 to rapidly return to the neutral-engagement position as a result of the biasing force provided by the biasing member 262. Such a unidirectional active rotation of the driveshaft 106 by the motor 66 may be accomplished, for example, through the clutch or disengaging configurations, which utilize the biasing member 262 to generate part of the reciprocating motion, substantially as described herein. As discussed previously, these slippage arrangements, in combination with the biasing member, allow one or both of the driveshaft 106 to rotate freely in response to the biasing force acting upon the lever arm 238. In this manner, the actuator assembly 82 may provide movement or action to the fishing line 46 that is transmitted to the lure 38.

Referring further to FIGS. 9-11, in various examples, the actuator assembly 82 may include a transmission arm 270 having a first transmission end 274 and a second transmission end 278. The first transmission end 274 of the transmission arm 270 is coupled to the second lever end 246 of the lever arm 238. The second transmission end 278 of the transmission arm 270 acts upon the fishing line 46. The motor 66 acts upon the driveshaft 106 to impart motion to the lever arm 238. The motion imparted to the lever arm 238 by the driveshaft 106 is transmitted to the transmission arm 270. The coupling between the lever arm 238 and the transmission arm 270 may provide a pivot point such that rotational or pivotal motion imparted to the lever arm 238 by the rotation of the driveshaft 106 may be transformed into linear or substantially linear motion of the transmission arm 270. The movement of the transmission arm 270 is transmitted to the fishing line 46 and ultimately to the lure 38 that is associated with the fishing line 46.

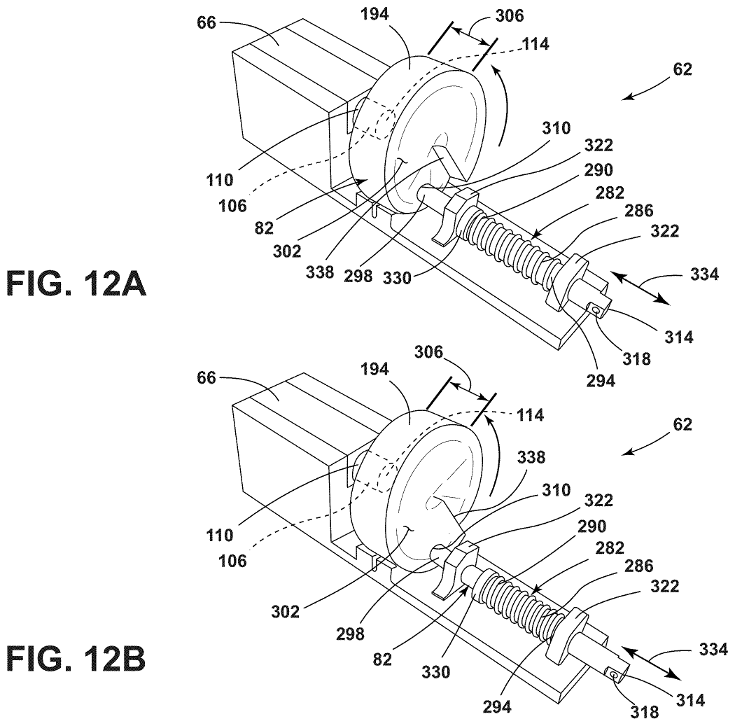

Referring to FIGS. 12A-14 and 19, the actuator assembly 82 includes the driveshaft 106 having the first end 110 and the second end 114. The first end 110 of the driveshaft 106 engages with the motor 66. The cam 194 is coupled to the second end 114 of the driveshaft 106. In some examples, the actuator assembly 82 includes a biasing member 282 that defines an aperture 286. The aperture 286 extends between a first biasing end 290 and a second biasing end 294 of the biasing member 282. A rod 298 may extend through the aperture 286 defined by the biasing member 282 and engage with the cam 194. Accordingly, the biasing member 282 may encircle the rod 298. As the motor 66 drives the driveshaft 106 through rotational motion, the cam 194 is likewise driven through rotational motion. In the depicted examples, a rod-engaging surface 302 of the cam 194 may be radially sloped. That is, a thickness 306 of the cam 194 may vary as a function of radial position on the rod-engaging surface 302. A first rod end 310 of the rod 298 engages with the rod-engaging surface 302 of the cam 194. A second rod end 314 of the rod 298 defines an aperture 318 that couples to the fishing line 46. The rod 298 engages with one or more guide brackets 322 that aid in guiding the rod 298 as the rod 298 is operated between a retracted position (e.g., FIG. 12A) and an extended position (e.g., FIG. 12B).

Alternatively, the rod 298 and the biasing member 282 may be positioned within a guide channel 326 defined by the housing 74 of the fishing device 62. A collar 330 may be fixed to the rod 298. The biasing member 282 may be positioned between the collar 330 and one of the guide brackets 322 or positioned between the collar 330 and a portion of the housing 74. As the cam 194 is rotated by the motor 66, the rod 298 is typically actuated in a back-and-forth manner as indicated by arrow 334. More specifically, the radially-sloped nature of the rod-engaging surface 302 gradually generates slack in the fishing line 46 such that the lure 38 appears to decrease its speed moving through the water 58. As the rod 298 traverses the rod-engaging surface 302 of the cam 194, the biasing member 282 is compressed and potential energy is stored in the biasing member 282. As the cam 194 approaches a full rotation, the rod 298 approaches an abrupt change in the thickness 306 of the cam 194. The abrupt change in the thickness 306 of the cam 194 may be referred to as a shelf or cliff 338. As the rod 298 passes over the cliff 338, the rod 298 rapidly accelerates toward the rod-engaging surface 302 of the cam 194 as the stored potential energy of the biasing member 282 is at least partially released or converted into motion of the rod 298 as indicated by arrow 334. This rapid motion of the rod 298 may provide a “quick jerk” of the lure 38 that rapidly accelerates the lure 38 through the water 58. Continued rotation of the cam 194 therefore results in a periodically varied travel speed of the lure 38 that may more accurately represent behavior of bait that the fish 34 finds enticing, which may result in the fish 34 striking the lure 38. In examples that utilize the cliff 338, the motor 66 may rotate the cam 194 in a single direction (e.g., counter-clockwise) to prevent the rod 298 from becoming stuck or otherwise hung-up as a side surface of the rod 298 strikes a face of the cliff 338.

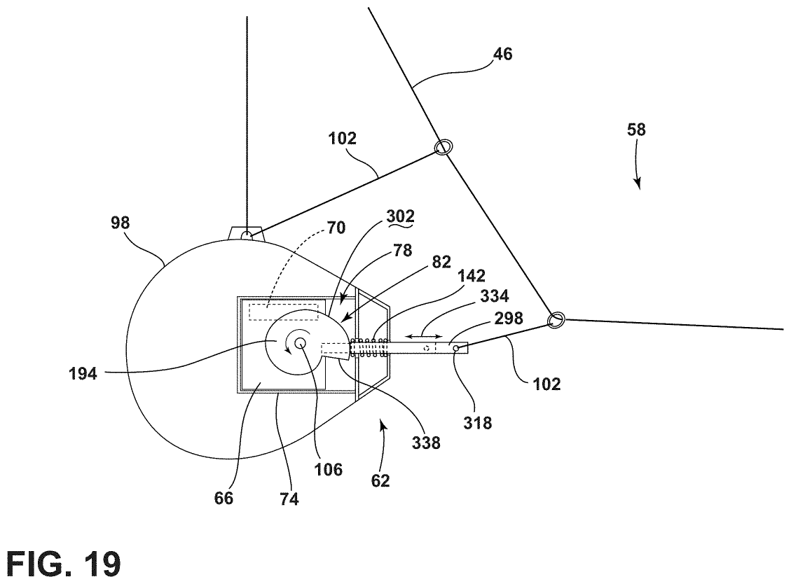

As exemplified in FIG. 19, the actuator assembly 82 can include the cam 194 having the cam surface that includes the cliff 338 defined around an edge of the cam 194. In this configuration, the rod 298 operates in an axial direction that is generally perpendicular to an axis of rotation of the driveshaft 106. This configuration, as well as other configurations of the actuator assembly can be incorporated within various components of a downrigger assembly, such as the weighting mechanism, which is frequently called a “cannonball” of the downrigger. Within this assembly, the fishing line 46 can be attached to the downrigger assembly via one or more release lines 102. While two release lines are exemplified in FIG. 19, it should be understood that additional release lines 102 can be used as well as a single release line 102 or no release lines 102.

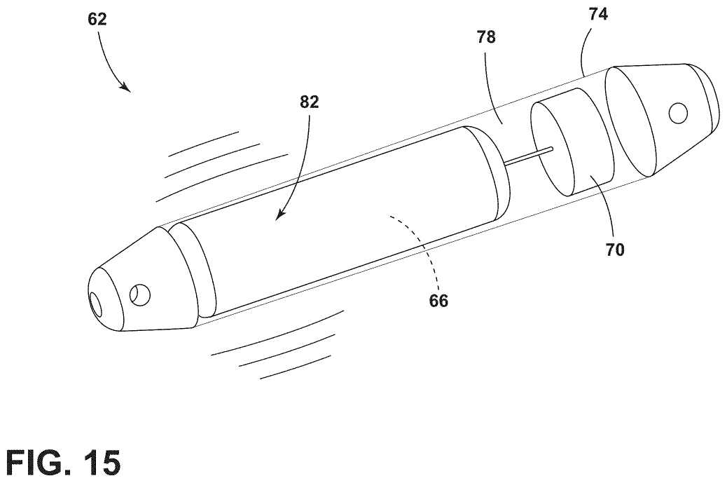

Referring now to FIG. 15, the actuator assembly 82 of the fishing device 62 may impart movement to the fishing line 46 by inducing a jigging motion, such as the back-and-forth motion described above, of the fishing line 46 and/or the lure 38. Additionally or alternatively, the actuator assembly 82 of the fishing device 62 may impart movement to the fishing line 46 by providing vibration to the fishing device 62, which is transmitted to the fishing line 46 and ultimately the lure 38. The vibration that is provided to the fishing device 62 can be provided by a vibratory motor within the actuator assembly 82 or separate from the actuator assembly 82. In some examples, a first fishing device may be responsible for providing jigging motion while a second fishing device is responsible for vibratory motion. The vibratory motor may attract the fish 34 by providing a “rattle” sound that may propagate through the water 58. The vibration producing actuator assembly 82 can be disposed within an aspect of the fishing device 62 that is attached to an intermediate portion of the fishing line 46. The actuator assembly 82 can also be disposed within the lure 38 itself. By way of example and not limitation, aspects of the device, as exemplified in the FIGS., and in particular FIGS. 12A-15, the fishing device 62 can be in the form of the lure 38 with a hook or other bait location attached to the actuator assembly 82 or a housing thereof.

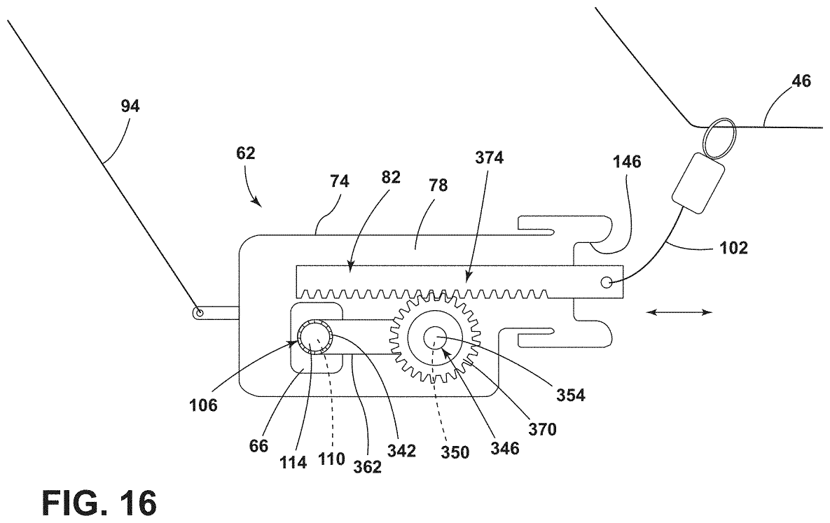

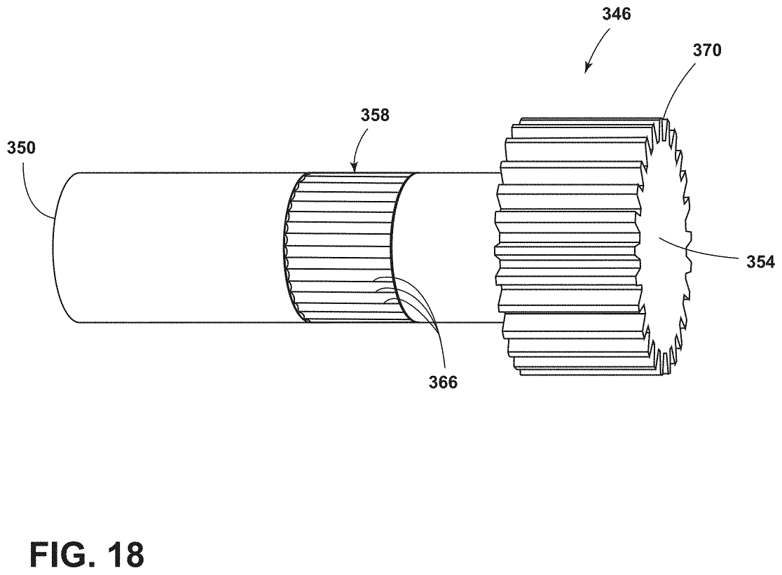

Referring to FIGS. 16-18, the actuator assembly 82 of the fishing device 62 includes the driveshaft 106 having the first end 110 and the second end 114. The first end 110 engages with the motor 66. A belt gear 342 is coupled to the second end 114 of the drive shaft 106. The actuator assembly 82 also includes a transmission shaft 346 having a first shaft end 350 and a second shaft end 354. In some examples, the first shaft end 350 may engage with the housing 74, for example, as an anchoring point while maintaining the transmission shaft 346 as free to rotate. A transmission gear 358 (see FIG. 18) is defined by the transmission shaft 346 and is positioned between the first shaft end 350 and the second shaft end 354. A belt 362 extends between the belt gear 342 of the driveshaft 106 and the transmission gear 358 of the transmission shaft 346. The belt 362 may be provided with alternating ridges and valleys positioned along an interior surface of the belt 362. The ridges and valleys of the belt 362 can engage with corresponding and complementary transmission teeth 366 of the transmission gear 358. The engagement between the driveshaft 106, the belt 362, and the transmission shaft 346 enables transmission of rotational motion of the driveshaft 106 by the motor 66 into rotational motion of the transmission shaft 346.

In various examples, a pinion gear 370 may be coupled to the second shaft end 354 of the transmission shaft 346. In some examples, the pinion gear 370 may engage with a rack 374 such that rotational motion of the transmission shaft 346 is translated into linear or substantially linear motion of the rack 374 relative to the housing 74. In alternative examples, the pinion gear 370 may engage with a rocker arm 378 such that rotational motion of the transmission shaft 346 is translated into a pivoting or “rocking” motion of the rocker arm 378. In either instance, the motion imparted to the transmission shaft 346 by way of the belt 362 results in a back-and-forth motion of either the rack 374 or the rocker arm 378.

In their corresponding examples, the rack 374 and the rocker arm 378 are coupled to the fishing line 46. Accordingly, the movement of the rack 374 or the rocker arm 378 is transmitted to the fishing line 46 and ultimately the lure 38, thereby providing the lure 38 with a more enticing presentation to the fish 34. In their respective examples, the rack 374 and the rocker arm 378 extend to a region that is exterior to the housing 74. The resilient member 146 may be provided in an effort to prevent the water 58 from interacting with internal components of the fishing device 62.

When the fish 34 strikes the lure 38, a sudden and substantial force may be experienced by at least some of the components of the fishing device 62. For example, driven components (e.g., motor 66, driveshaft 106, transmission shaft 346, rack 374, and/or rocker arm 378) of the fishing device 62 may experience the sudden and substantial force resulting from the strike of the fish 34. The sudden and substantial force resulting from the strike of the fish 34 may be a result of a weight of the fish 34, a setting of a hook of the lure 38 by the angler, and/or by the fish 34 beginning to fight against the angler. The sudden and substantial force may cause the transmission shaft 346 to spin rapidly at least momentarily. In such an instance, the belt 362 may be allowed to slip such that the sudden and substantial force resulting from the strike of the fish 34 is not transmitted from the transmission shaft 346 to the driveshaft 106 and the motor 66 by way of the belt 362. Accordingly, the internal components of the fishing device 62 that are responsible for providing the movement to the fishing line 46 and ultimately the lure 38 may be prevented from damage that may otherwise occur as a result of the sudden and substantial force applied during the strike of the fish 34.

According to the various aspects of the device, the actuating mechanism 82 typically includes a motor 66 and an actuator, where the motor drives the operation of the actuator for the actuating mechanism 82. The motor 66 that powers the actuator for the actuating assembly 82 of the fishing device 62 can be any one of various motors 66. Such motors 66 can include, but are not limited to, solenoids, stepper motors, servo motors, motors having inner or outer rotor configurations, direct drive motors, linear motors, squirrel cage motors, single-phase or three-phase motors, combinations thereof and other similar motor configurations. Typically, the motor 66 for the fishing device is powered by a power cell such as a battery or other similar power source. Depending on the particular application, solar power and other renewable power sources can be utilized.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A fishing device for engagement with a fishing line, comprising:
a motor;
a power source that provides power to the motor;
a housing that defines an interior cavity, wherein the housing prevents water from interacting with the power source and at least a portion of the motor; and
an actuator assembly that is driven by the motor, wherein the actuator assembly is configured to provide movement to the fishing line.

2. The fishing device for engagement with a fishing line of claim 1, wherein the movement provided to the fishing line by the actuator assembly is accomplished without spooling the fishing line.

3. The fishing device for engagement with a fishing line of claim 1, wherein the actuator assembly comprises:
a driveshaft having a first end and a second end, the first end engaging with the motor;
a pinion gear coupled to the second end of the driveshaft; and
a rack having a first portion and a second portion, wherein the rack engages with the pinion gear, and wherein the rack is operable between a retracted position and an extended position.

4. The fishing device for engagement with a fishing line of claim 3, wherein the first portion of the rack is positioned within the interior cavity defined by the housing, and wherein the second portion of the rack extends to a region that is exterior to the housing.

5. The fishing device for engagement with a fishing line of claim 4, further comprising:
a resilient member coupled to the housing and the second portion of the rack.

6. The fishing device for engagement with a fishing line of claim 5, wherein the resilient member is operable between a compressed position and an extended position.

7. The fishing device for engagement with a fishing line of claim 6, wherein the compressed position of the resilient member corresponds with the retracted position of the rack, and wherein the extended position of the resilient member corresponds with the extended position of the rack.

8. The fishing device for engagement with a fishing line of claim 1, wherein the actuator assembly comprises:
a driveshaft having a first end and a second end, the first end engaging with the motor; and
a cam coupled to the second end of the driveshaft.

9. The fishing device for engagement with a fishing line of claim 8, wherein the actuator assembly further comprises:
a linkage arm having a first linkage end and a second linkage end, wherein the first linkage end engages with the cam.

10. The fishing device for engagement with a fishing line of claim 9, wherein the actuator assembly further comprises:
a fulcrum positioned between the first linkage end and the second linkage end of the linkage arm.

11. The fishing device for engagement with a fishing line of claim 9, wherein the actuator assembly further comprises:
a linkage extension coupled to the second linkage end of the linkage arm.

12. The fishing device for engagement with a fishing line of claim 8, wherein the actuator assembly further comprises:
a biasing member that defines an aperture, wherein the aperture extends between a first biasing end and a second biasing end of the biasing member; and
a rod that engages with the cam and extends through the aperture.

13. The fishing device for engagement with a fishing line of claim 1, wherein the actuator assembly comprises:
a driveshaft having a first end and a second end, the first end engaging with the motor; and
a lever arm having a first lever end and a second lever end, wherein the first lever end of the lever arm is coupled to the second end of the driveshaft.

14. The fishing device for engagement with a fishing line of claim 13, wherein the lever arm comprises:
a line-engagement portion at the second lever end of the lever arm, wherein the line-engagement portion acts upon the fishing line.

15. The fishing device for engagement with a fishing line of claim 14, further comprising:
a biasing member coupled to the lever arm, wherein the biasing member biases the lever arm to a neutral-engagement position relative to the fishing line.

16. The fishing device for engagement with a fishing line of claim 13, further comprising:
a transmission arm having a first transmission end and a second transmission end, wherein the first transmission end of the transmission arm is coupled to the second lever end of the lever arm, and wherein the second transmission end of the transmission arm acts upon the fishing line.

17. The fishing device for engagement with a fishing line of claim 1, wherein the actuator assembly comprises:
a driveshaft having a first end and a second end, the first end engaging with the motor;
a belt gear coupled to the second end of the driveshaft;
a transmission shaft having a first shaft end and a second shaft end, the first shaft end engaging with the housing;
a transmission gear defined by the transmission shaft and positioned between the first shaft end and the second shaft end of the transmission shaft; and
a belt extending between the belt gear of the driveshaft and the transmission gear of the transmission shaft.

18. The fishing device for engagement with a fishing line of claim 17, further comprising:
a pinion gear coupled to the second shaft end of the transmission shaft; and
a rack that engages with the pinion gear.

19. The fishing device for engagement with a fishing line of claim 17, further comprising:
a pinion gear coupled to the second shaft end of the transmission shaft; and
a rocker arm that engages with the pinion gear.

20. The fishing device for engagement with a fishing line of claim 1, wherein the movement imparted to the fishing line by the actuator assembly provides at least one action chosen from vibration and jigging.
